(19) United States
(12) Patent Application Publication
(10) Pub. No.: US 2011/0099519 A1
(43) Pub. Date: Apr. 28, 2011

(54) Menuing Structure for Media Content

(75) Inventors: Jeffrey Ma, Emerald Hills, CA (US); Elbert D. Chen, Cupertino, CA (US); Jeffrey Robbin, Los Altos, CA (US); Calin Pacurariu, Los Gatos, CA (US); William Martin Bachman, San Jose, CA (US); James A. Young, Livermore, CA (US)

(73) Assignee: APPLE INC., Cupertino, CA (US)

(21) Appl. No.: 12/860,828

(22) Filed: Aug. 20, 2010

Related U.S. Application Data
(60) Provisional application No. 61/255,390, filed on Oct. 27, 2009.

(51) Int. Cl. G06F 3/048

(52) U.S. Cl. 715/811

(57) ABSTRACT

Methods, systems, articles of manufacture, and apparatus for causing a computer system such as a media device to perform operations may include receiving input from the user selecting a media type category, identifying media content items within the selected media category that the user has previously selected for presentation, prioritizing the identified media content items based on a predetermined set of rules, and presenting to the user a menu of at least some of the identified media content items in an order based on a result of the prioritization.

### PRIORITY CLAIM AND RELATED APPLICATIONS

This patent document claims priority from U.S. Provisional Application No. 61/255,390 entitled “Menuing Structure for Media Content” and filed Oct. 27, 2009, which is incorporated by reference as part of the disclosure of this document.

### BACKGROUND

This disclosure relates to a menuing structure for presenting items of media content (e.g., video, audio, still images) that are available on a media device.

Generally speaking, a media device, also known as a digital media receiver or digital media adapter, is a special purpose computer system that can connect to a packet-switched network to retrieve digital media files or streams (such as music, pictures or video) from a personal computer or other media server and play them back on a home theater system or TV. As media devices and online providers of media content have become more prevalent, the choices of media types and selection of particular media items have grown considerably and will continue to do so. Manufacturers of media devices strive to present this vast array of available media choices to a viewer in a meaningful way.

### SUMMARY

The disclosed media menuing structure enables the presentation of multiple different types of media (e.g., movies, TV shows, music, photos, podcasts and websites) in a user-friendly and intuitive manner. In general, in one aspect, the subject matter described here can be implemented to include using a computer system to perform a method, an article of manufacture having machine-accessible instructions to cause a machine to perform the method, and/or a device or other apparatus having memory storing instructions and a processor configured to execute the stored instructions to perform the method.

In an implementation, the method may include receiving input from the user selecting a media type category, identifying media content items within the selected media category that the user has previously selected for presentation, prioritizing the identified media content items based on a predetermined set of rules, and presenting to the user a menu of at least some of the identified media content items in an order based on a result of the prioritization.

Optionally, the method may include one or more of the following aspects: displaying indicia in the menu indicating to which of a plurality of different groups the presented media content items belong; the groups may vary with the selected media type category; at least one of the groups may correspond to items of media that are not yet completely played back; at least of the groups may correspond to items of media recently acquired; at least of the groups may correspond to items of media with upcoming expiration times; at least of the groups may correspond to items of media that have been recently accessed; at least of the groups may correspond to items of media that are popular according to a predefined metric; at least of the groups may correspond to items of media that the user has not yet acquired; presenting a menu to the user may include displaying at least two separate regions including a media type region in which a plurality of different media type categories are displayed and a shelf region in which individual media content items are displayed; the media content items may be displayed in shelf region change in response to change in choice of media type category; when an insufficient quantity of media content items exists to fill the shelf, a remainder of the shelf may be filled with media content items selected by a third party; designing the set of predetermined rules to result in prioritization of media content items that the user is most likely to want to access; designing the set of predetermined rules to result in media content items that the user is most likely to want to access having a high priority; and/or designing the set of predetermined rules to result in media content items that the user has most recently acquired having a high priority.

The subject matter described in this document can be implemented to realize one or more of the following potential advantages. For example, a media menuing structure can be implemented that makes intelligent choices about the media content items most likely to be of interest to a user. Those media items, which tend to be the newest and freshest items of media content, are displayed and made available to the user in a prominent location within the menu structure, thereby facilitating ease of access and increasing the likelihood that they will be noticed by the user.

The details of one or more implementations are set forth in the accompanying drawings and the description below. Other features and potential advantages will be apparent from the description and drawings, and from the claims.

### BRIEF DESCRIPTION OF THE DRAWINGS

FIG. 1 is an example of a media system including a media client.

FIGS. 2-5 are screenshots of a menuing system for displaying media content choices to a user.

FIG. 6 is a flowchart of a process for generating a menu of available media items for presentation to a user.

FIG. 7 is an example of a media client architecture.

Like reference symbols indicate like elements throughout the specification and drawings.

### DETAILED DESCRIPTION

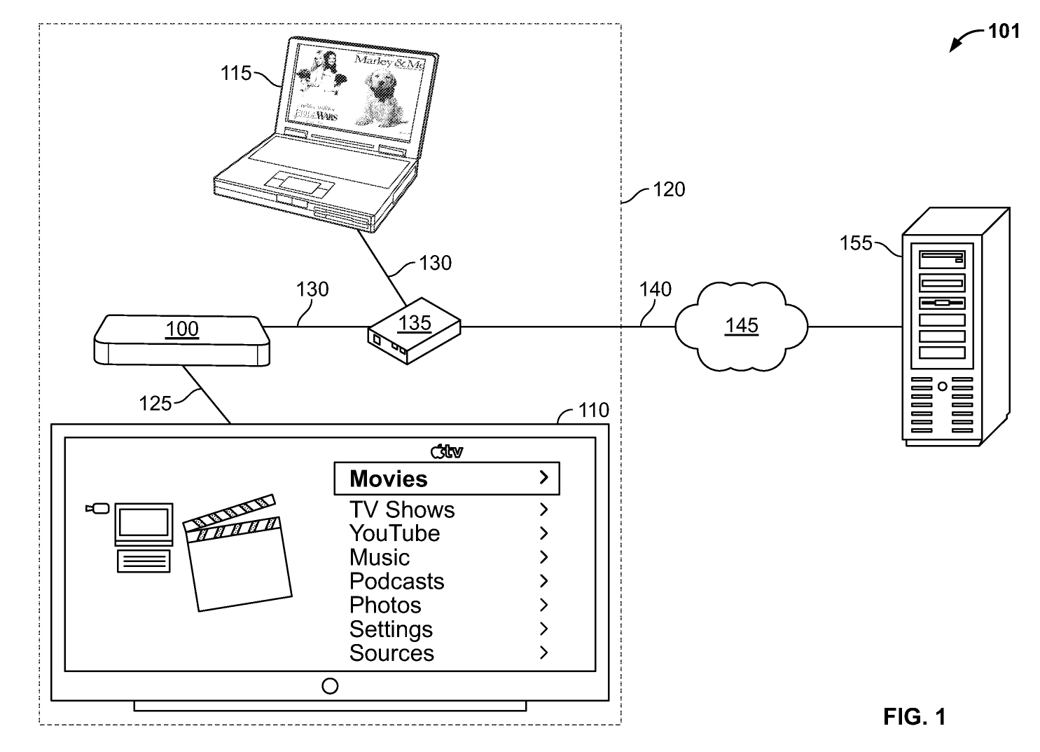

FIG. 1 shows a media system 101 that includes a media client 100, such as an Apple TV device, which can be configured to present media content, including movies, TV shows, music, photos, podcasts and websites, video, and to provide a user interface with a menuing structure that facilitates the navigation and selection of media item choices. The media system 101 includes a client location 120, such as a home or office, in which the media client 100 resides. The client location 120 also can include a local media server 115, such as a notebook computer executing an appropriate software application (e.g., iTunes), and a presentation device, such as a TV set or monitor 110. The monitor 110 can be coupled to the media client 100 through a media connector 125, such that video and/or audio information output by the media client 100 can be presented through the monitor 110. Further, the media client 100 can be coupled to the local media server 115 through a local connection 130, such as either a wired or wireless network connection. As such, the media client 100 can receive media content from the local media server 115. The local media server 115 can be any suitable computing device, including a notebook or desktop computer, a server, a handheld device, or a media device capable of storing and/or playing back media content.

Further, the client location 120 can have a network connection 140 that provides access, via modem (or other network access device) 135 to a network 145, such as the Internet or another packet-switched network. By virtue of the network connection 140, the media client 100 and/or the local media server 115 can be configured to access media content from essentially any suitable media content provider connected to network 145, including for example a media store 155 such as the iTunes Store, from which a user can obtain media content.

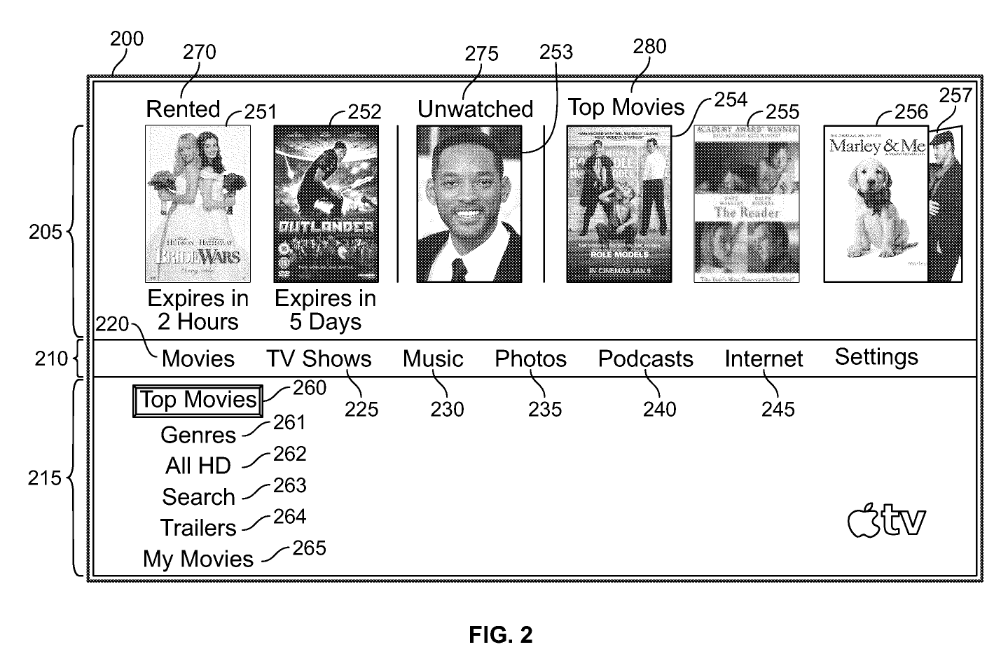

FIG. 2 depicts an example screen shot of a top-level media menu 200 with which a user of the media device 100 can interact to browse and select items of media content for playback. The menu 200 includes 3 different regions including a shelf region 205 for displaying individual items of media content, a media type category region 210, which includes names of different media type categories (as shown Movies 220, TV Shows 225, Music 230, Photos 235, Podcasts 240, Internet 245), and a sub-category region 215, in which sub-category menu options are displayed for each associated media type category.

The media device user typically interacts with the media device by means of a wireless remote control device (not shown), which the user can manipulate to move the cursor focus among the different selectable menu items. As depicted in FIG. 2, the user has manipulated the remote control to place the focus on “Top Movies” 260, the topmost sub-category choice under the Movies category 220. As used herein, the term “Top Movies” refers to movies that, according to some metric, have been deemed by a third party entity (e.g., the entity that operates the media store 155) to be the best, most popular or otherwise superlative. If at this point, the user were to select the Top Movies sub-category 260, e.g., by clicking a button on the remote control, the media device would respond by displaying an entirely different menu screen related to Top Movies. On the other hand, if the user did not select Top Movies 260 but rather manipulated the remote control to move the focus vertically downward, the screen display would remain essentially identical as shown in FIG. 2 except that the visual indication of the current focus would be re-displayed to be on Genres 261. In this manner, the user can manipulate the cursor up and/or down within the same vertical column to select among the various sub-category menu choices. In general, selection of any of these sub-category menu choices would result in the media device 100 changing the screen to display a different menu associated with the selected sub-category choice.

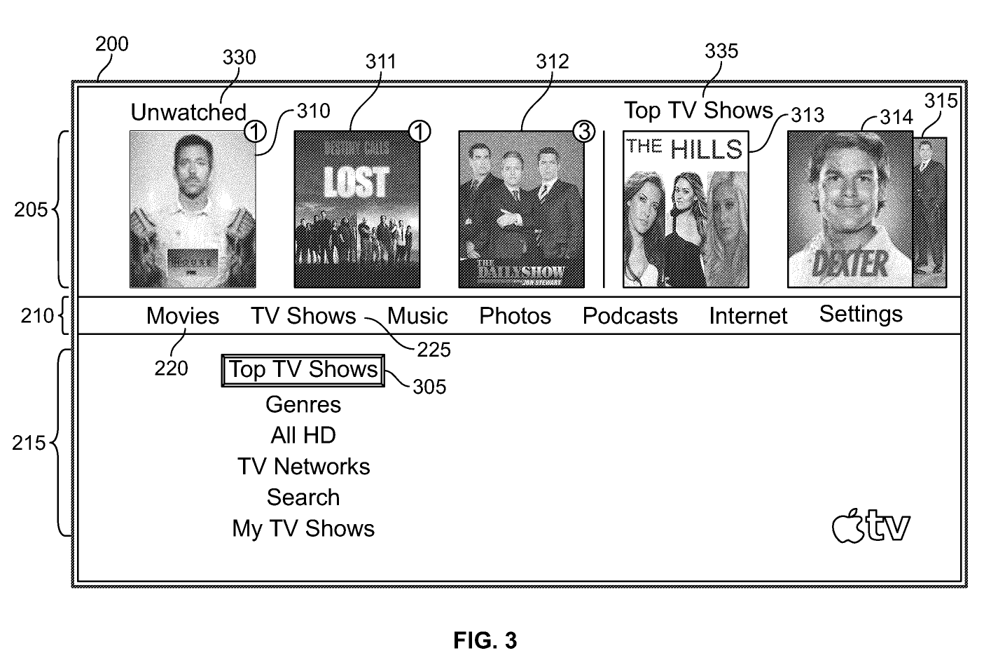

If, however, the user manipulates the remote control to move the focus horizontally right at the moment in shown in FIG. 2, regardless of which Movies sub-category happened to be the current focus, the focus would change to the TV Shows category 225 and, as shown in FIG. 3, the sub-category menu choices for the TV Shows category 225 would be displayed (and concurrently the Movies sub-categories menu choices would disappear from view since the Movies category 220 was no longer the focus). When changing the focus from one media type category to another (e.g., from Movies 220 to TV Shows 225), the particular sub-category menu choice that receives the focus is the sub-category menu choice that had the focus the last time the user left that media type category. In FIG. 3, the focus was received by Top TV Shows 305, indicating that the last time the user was visiting the TV Shows category 22, the Top TV Shows sub-category 305 had the focus at the moment when the user moved the focus left or right to chose a new media type category. Either that, or the media device 100 is brand new or has been re-booted or re-set, in which case the uppermost sub-category menu choice becomes the default to receive the focus.

As described above, the user can manipulate the remote control to move the focus left and right to select different media type categories and/or up and down to select among the different sub-category menu choices relating to the currently selected media type category. If, however, the focus is at the topmost sub-category menu choice and the user moves the focus upwards from there, the focus jumps into the shelf region 205, and lands on one of the individual items of media content displayed therein. (The region 210 is solely for display purposes and is not configured to receive the focus.) As with moving from one media type category to another, when moving into the shelf region 205, the focus is received by the particular media content that last had the focus before the user moved to a new media type category or, in the case of a new or re-started media device 100, the focus is received by default on the leftmost item of media content on the shelf 205.

Once in the shelf region, the user can move the focus down again to re-enter the subcategory menu region 215 for the currently active media type. In addition, the user can move the focus left and right to select among the various items displayed along the shelf 205. The media item displayed leftmost (e.g., item 310 in FIG. 3) on the shelf region 205 represents a stopping point beyond which the focus can travel no further in that direction. At the rightmost side of the shelf region, however, once the focus has reached the farthest right displayed media item (e.g., item 315 in FIG. 3), the user can still move the focus farther right to access the next, yet presently unseen item of media content. As the focus keeps moving to the right, the shelf display changes, effectively scrolling to the left (meaning leftmost items become no longer visible) to accommodate previously undisplayed items to scroll onto the shelf 205 and into view. An implementation of such scrolling behavior is known as “Cover Flow.”

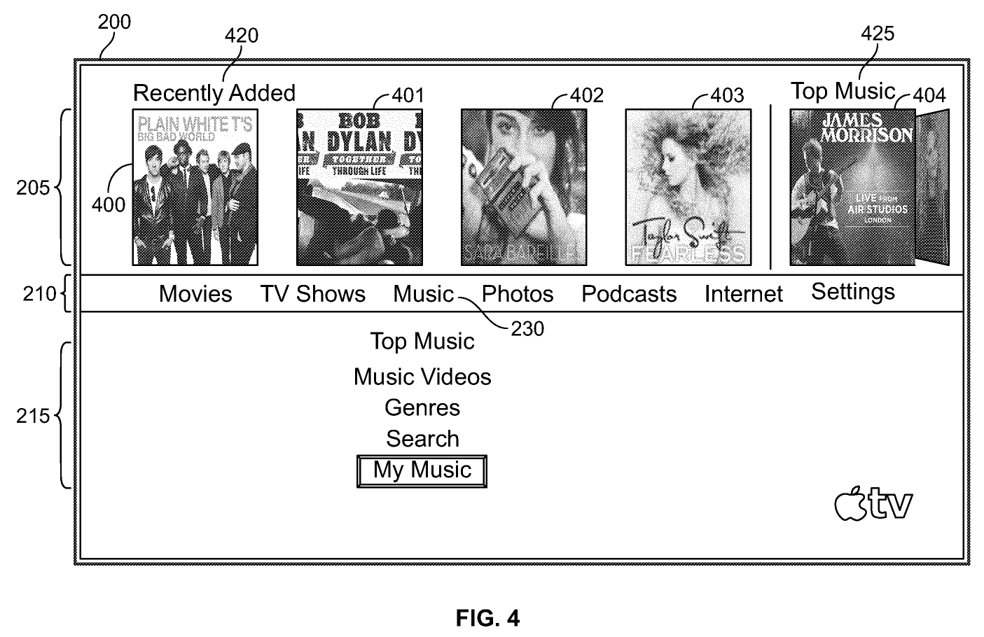

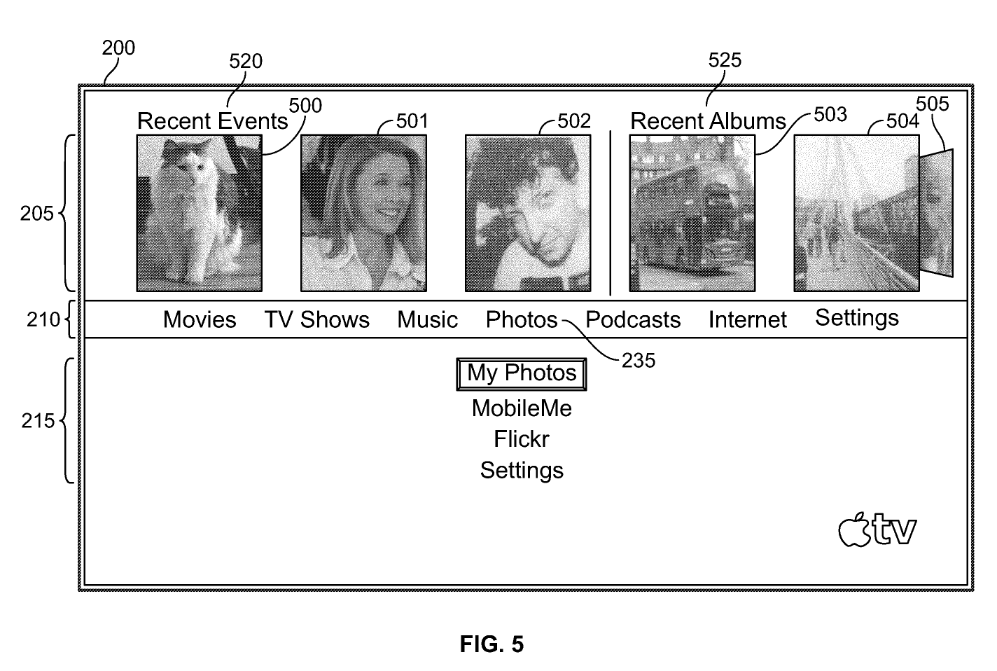

As can be seen by comparing FIGS. 2-5, the particular items of media content displayed in the shelf 205 change in response to a change of the media type category. For example, comparing FIGS. 2 and 3, before the user changes the focus from Movies 220 the individual items of media content displayed in the shelf 205 are movies, in this example, seven different movies 251-257 are visible in the shelf 205 as shown in FIG. 2. In contrast, as soon as the user changes the focus to TV Shows 225, the shelf display changes to display individual items of media content corresponding to TV Shows as shown in FIG. 3. Similarly, the media content items displayed on the shelf 205 change to six items of music media content 400-405 (specifically, albums) when in the Music category 230 as shown in FIG. 4, to six items of photo media content 500-505 when in the Photos category 235 as shown in FIG. 5, and to items of Podcast media content when in the Podcasts 240 category (not shown).

An inspection of FIGS. 2-5 also shows that, in addition to changing the items displayed on the shelf 205 in response to changing media type category, the particular media items displayed are separated into different groups or groupings, which also can vary based on media type category. For example, when in the Movies category 220, the media items displayed on the shelf 205 are separated into three different groupings as indicated by descriptive indicia, specifically by displaying the group headings “Rented” 270, “Unwatched” 275 and “Top Movies” 280. As seen in FIGS. 3-5, other media type categories can be grouped for display on the shelf 205 under different grouping criteria. For example, as shown in FIG. 3, the individual items of TV show media content 310-315 also are divided into three different groupings, “Rented” (not shown), “Unwatched” 330 and “Top TV Shows.” As shown in FIG. 4, media items on the shelf 205 while in Music 230 are grouped into “Recently Added” 420 and “Top Music” 425. When in the Photos category 235 as shown in FIG. 5, the shelf items are grouped in “Recent Events” 520 and “Recent Albums” 525.

Depending on a system designer's objectives, additional or different shelf groupings of media items can be used as desired. In an implementation of a media menu, shelf groupings can be designed to help ensure that a predicted optimal choice of content is made available to the user via the shelf region 205, which holds a prominent position in the menu 200 and thus makes user access to the identified optimal choices quick, easy and intuitive.

The predicted optimal choices can vary with the media category type. For example, in the Movies category, the user likely will want to watch movies that he or she has not yet watched (or not completed watching) but has previously taken actions that suggest that he or she wants to watch them. In the case of movies, if the user has previously rented or purchased a movie, it is reasonable to assume that the user will want to watch the rented or purchase movie in the relatively near future. Accordingly, the shelf groupings depicted in FIGS. 2, namely, Rented 270 in this context indicates a movie that has been rented from the media store but not yet completely watched or not yet expired) and Unwatched 275 (which indicates a movie that was purchased from the media store but not yet completely watched), were designed to further these assumptions by identifying unwatched movies that have been rented or purchased by the user and then displaying these prominently on the shelf.

The shelf groupings used for a particular media category can have priorities relative to each other, which are used by the media device to make decisions about which individual media items to display. For example, as shown in FIG. 2, the Rented grouping 270 has a higher priority than either the Unwatched grouping 275 or the Top Movies grouping 280, and thus is displayed before (i.e., to the left of, based on the reading direction of western hemisphere languages) either of those grouping. The rationale for doing so is that rented movies necessarily expire and thus have a higher degree of urgency to be watched before they do so. Using this same logic, rented movies with the shortest expiration time are displayed before (to the left of) rented movies with longer expiration times. Purchased movies, which in contrast, do not expire and thus have a lower degree of urgency to be watched, have a lower priority than rented movies and thus are displayed on the shelf after (to the right of) rented movies.

As shown in FIG. 3, the shelf groupings for the TV Shows category are similar to those for movies, in that TV series with unwatched episodes fall within a grouping (Unwatched 330) that is displayed first (leftmost), meaning that this grouping has the highest priority for TV Shows media. Similarly, shelf groupings for the Music media type category 230 give highest priority to the newest music media items. As shown in FIG. 4, the grouping 420 “Recently Added” is given the highest priority and thus is displayed leftmost on the shelf 205 while in the Music media type category. Music items within that grouping also are prioritized relative to each other based on newness to the user, which the most recently added music item 400 being displayed leftmost within the grouping 420.

The groupings used in the Photos media type category also are designed to give highest priority to the newest or freshest items of photo content. As shown in FIG. 5, the “Recent Events” grouping 520 has the highest priority, and thus is displayed to the left of “Recent Albums” 525. As with other groupings, individual items within either of these groupings can be prioritized and positioned within the grouping accordingly. Although not shown in a figure, the shelf groupings used for the Podcasts media type category also can be implemented based on giving the newest or freshest content the highest priority. For example, an “Unplayed” grouping (referring to un-listened-to or un-watched episodes of podcasts to which the user had previously subscribed) could be given the highest priority and thus displayed leftmost on the shelf while in the Podcasts media type category 240.

In contrast, in the Internet category 245—which refers to websites or other resources on the Internet that provide streaming audio and/or video feeds (e.g., Internet radio stations are an example of the former and Youtube is an example of the latter)—shelf groupings and prioritizations need not necessarily focus on the newest or freshest content. For example, an assumption can be made that, in the case of Internet radio stations, users tend to find a few favorites and then stick with them, at least temporarily, meaning that they would like to listen to one or more of the same Internet radio stations that they listened to the last time they listened to Internet radio. Accordingly, a shelf grouping based on the last few (e.g., 3) radio stations accessed by the user could be used and given priority. In that case, when a user selected the Internet category 245, the shelf could be displayed with a leftmost grouping named “Recent Radio” that listed the last three Internet radio stations that the user accessed.

Alternatively, or in addition, the Internet category (or, for that matter, any of the aforementioned media type categories) could specify a “Now Playing” shelf grouping and give it highest priority, meaning that the particular item of media content currently being played back would be displayed leftmost on the shelf under the grouping “Now Playing.” Still further, other shelf groupings can be developed and used (and given suitable priorities) for special case situations, to emphasize specific online resources or services that might be of interest to the user. For example, certain online media sharing websites and/or mobile device access services might warrant special shelf groupings and priorities.

Another type of shelf grouping that can be used relates to using shelf space for marketing or advertising purposes. As shown in FIGS. 2-5, the shelf groupings Top Movies 280, Top TV Shows 335, and Top Music 425 are examples of advertising groupings. In some implementations, the advertising groupings can be based on one or more predetermined sets of rules. For example, in the case of Top Movies, the first N number of top movie rentals can be included in the advertising grouping. Typically, these groupings are given a very low or the lowest priority, meaning that they are the first to disappear from view whenever a shelf space shortage or conflict arises. In general, such advertising grouping are displayed on the shelf only when the user does not have any (or much) of his or her own content available. The rationale behind advertising groupings is that there represent a good use of shelf space that would otherwise go empty. In addition, full media shelves, even if full with media content that the user does not yet possess or have access to, tend to have a better visual appearance than empty shelves.

More generally, different shelf groupings could be used if different assumptions were made and/or if different objectives were sought to be realized. For example, one possible assumption is that a person would most likely want to listen to a song that he or she had been listening to frequently as of late. Accordingly, in a different implementation, a “Most Frequently Played” grouping and prioritization could be implemented for music media in which songs that the user had played the most (either in a recent window of time or historically) could be given the highest or a relatively high priority within the music media type, and thus songs that the user had played a lot would tend to be displayed leftmost on the shelf while in the Music media type category. In general, the different kinds of groupings and prioritizations for those groupings are limited only by the creativity of the system implementer. Another possible implementation, would be to allow users to choose their own groupings and/or priorities for any given media type, either by selecting from a list of pre-defined groupings, or by enabling users to construct their own.

As shown in FIGS. 2-5, the shelf can reasonably display only a limited number of media items at any given time. For example, while in the Movies category, seven different individual movies 251-257 are visible at one time, whereas the media categories TV Shows 225, Music 230, and Photos 235 each display six media content items on their respective shelves. Accordingly, to take into account the limited shelf space, certain display rules can be applied that affect parameters such as which groupings are displayed, how many media items are displayed in each grouping and in what order, and what should be displayed if empty space on the shelf needs to be filed and/or if the media device 100 has no active Internet connection or if the media store 155 is unavailable. An underlying rationale here is to make wise use of limited shelf space in a manner that enables all shelf groupings, or at least the more important shelf groupings, to occupy at least some visible shelf space while not crowding out the others, thereby making a selection of media items that span two or more groupings readily available and easily accessible to the user. At the same time, the shelf should, whenever possible, be displayed as full of available items.

Accordingly, a set of such shelf display rules can be as follows:

SHELF DISPLAY RULES
Higher priority shelf groupings are displayed before (i.e., to the left of) lower priority groupings
Within a shelf grouping, higher priority media items are displayed before (i.e., to the left of) lower priority media items
Except as otherwise provided, groupings related to newer, fresher, not-yet-played-back or more emergent media content items (e.g., content items about to expire and no longer be available) have a higher priority than older or previously played back media items
Except as otherwise provided, no grouping shall display more than three media items at a given time
If a grouping has no corresponding items of media content, then that grouping is not displayed and the next highest priority grouping takes its place
The rightmost shelf grouping (i.e., the displayed shelf grouping with the lowest priority) provides access to all of its media items (or up to a certain quantity, e.g., 25) by means of a Cover Flow or scrolling display effect
The shelf must have a minimum quantity of media items displayed, the minimum varying according to media type
If an insufficient quantity of media items are available to display on the shelf to meet the shelf media-type specific minimum quantity, then the maximum number of media items to be displayed per group for the highest priority group is raised until the shelf minimum is satisfied. If the highest priority group does not have enough extra media items to display to satisfy the shelf minimum, then the maximum per-group number of media items for the next highest shelf grouping is raised, and so on with decreasing shelf group priority, until the shelf minimum is satisfied.
The advertising groupings have the second lowest priorities and are displayed only if the other groupings in that media type do not have sufficient media items to fill the shelves
The lowest priority shelf groupings are the “Recent” groupings (referring to recently played or otherwise accessed media residing on the user's media device; each of the Movies, TV Shows, Music, Photos and Podcasts media categories can have a “Recent” grouping). If shelf space needs to be filled and the Advertising groupings are not available (e.g., due to lack of Internet connection or other lack of ability to access the media store), then media items from the “Recent” groupings will be used to fill the shelf to its required minimum. An alternative rule can include prioritizing “recent” groupings over Advertising groupings for selected categories. For example, recent radio stations can be prioritized higher than Advertising groupings for radio stations, while for all other groupings, “Recent” groupings receive a lower priority than Advertising groupings.
If all else fails (i.e., all of the rules above are implemented but there still are not enough media items to satisfy the shelf's minimum), display empty media containers (e.g., blank boxes) and/or display a notification (“Not Connected to Internet” or “No media store available”), as appropriate.

As with the grouping definitions, different or additional shelf display rules can be used depending on design objectives.

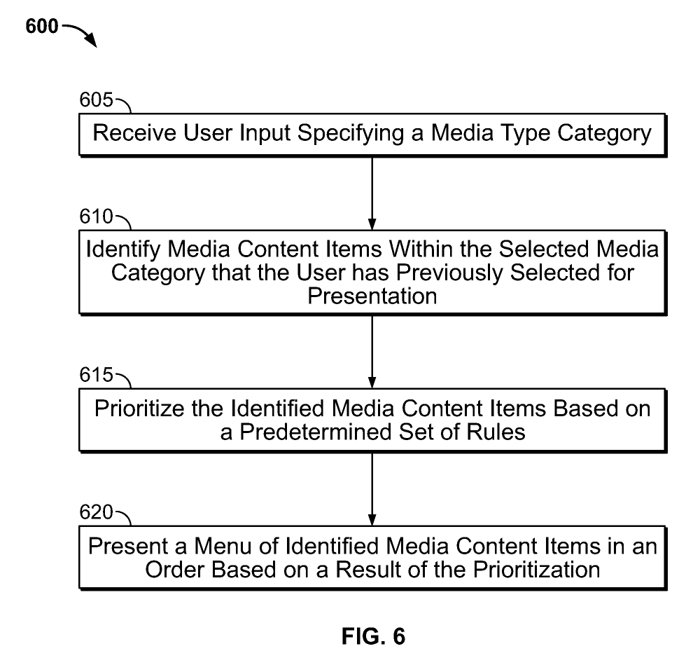

FIG. 6 is a flowchart of a process 600, performed for example by a media device, for generating a menu of available media items for presentation to a user. The process 600 is designed and intended to make an intelligent choice of available medium items, based on assumptions about which items of media content a typical user would likely be most interested in listening to and/or viewing next.

First, at 605, the process 600 receives user input specifying a media type category (e.g., Movies, TV Shows, Music, Photos, Podcasts, Internet). Next, at 610, the process 600 identifies media content items within the selected media category that the user previously has selected or otherwise marked for presentation (e.g., rented or purchased or downloaded from an online media store). Next, at 615, the process 600 prioritizes the identified media content items based on a predetermined set of rules, for example, the “Shelf Display Rules” set out above. Finally, at 620, the process presents to the user a menu of at least some of the identified media content items in an order based on a result of the prioritization. For example, a menu screen having a shelf region that is divided into groupings with relative priorities, and media items displayed within those groupings, can be generated and displayed to the user. Process 600 can be executed and thus produce a new menu display each time the user selects another media type category. Although depicted in FIG. 6 in stepwise fashion, the steps are not necessarily order dependent and can be performed in a different order, or simultaneously, when feasible to achieve essentially the same result. For example, the media device could maintain a database of available media items, and further could maintain state tables (e.g., indicating a media item's state such as “new,” “watched,” “expired” and the like) corresponding to available media items, their respective media categories, their respective groupings, the relative priorities of those groupings, and/or the relative priorities media items within each grouping. And the media device could maintain and update the database and/or state tables each time the universe of available media changed (e.g., a new item of media content is added to the media device and/or an existing media content item is deleted, watched, or expires). In that case, the steps 610 (identifying media content items with the selected media category) and/or 615 (prioritize the identified media content items based on a predetermined set of rules) essentially would have been performed ahead of time—that is, before the selection of a new media category occurred in step 605.

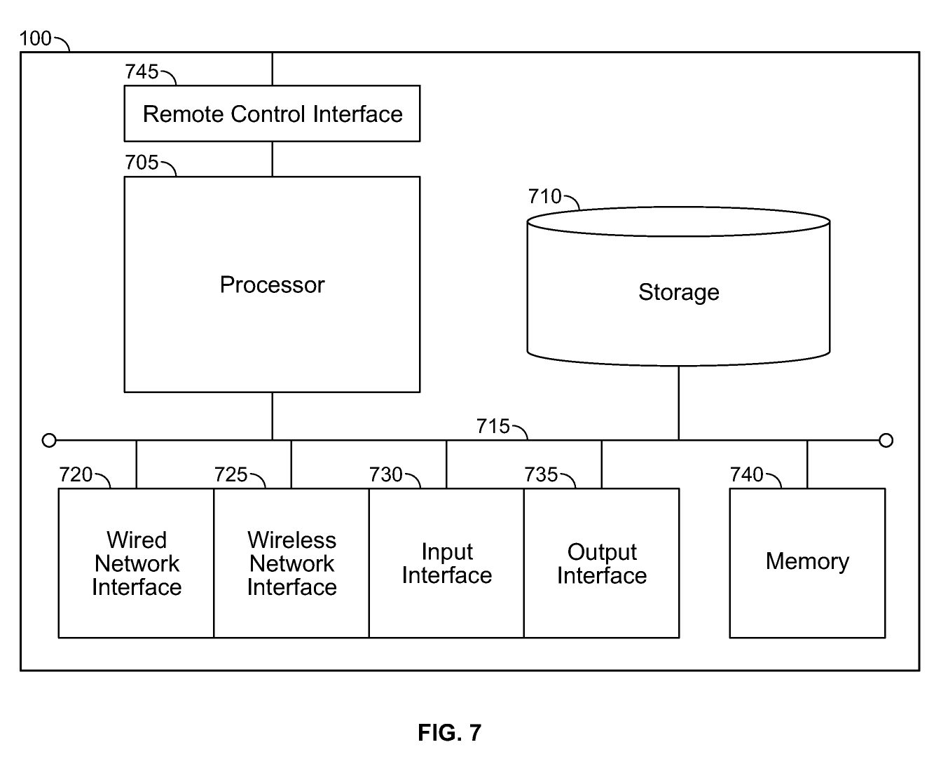

FIG. 7 depicts an exemplary architecture of the media client 100, which includes a processor 705 configured to control the operation of the media client 100. For example, the processor 705 can control communications with one or more media servers to receive media for playback. A media server can be any general purpose server that provides access to media content. The media can be received through push and/or pull operations, including through downloading and streaming. The processor 705 also can be configured to generate output signals for presentation, such as one or more streams representing media content or an interface for interacting with a user.

The media client 100 also includes a storage device 710 that can be configured to store information including media, configuration data, user preferences, and operating instructions. The storage device 710 can be any type of non-volatile storage, including a hard disk device or a solid-state drive. For example, media received from an external media server can be stored on the storage device 710. The received media thus can be locally accessed and processed. Further, configuration information, such as the resolution of a coupled display device or information identifying an associated media server, can be stored on the storage device 710. Additionally, the storage device 710 can include one or more sets of operating instructions that can be executed by the processor 705 to control operation of the media client 100. In an implementation, the storage device 710 further can be divided into a plurality of partitions, wherein each partition can be utilized to store one or more types of information. Additionally, each partition can have one or more access control provisions.

A communication bus 715 couples the processor 705 to the other components and interfaces included in the media client 100. The communication bus 715 can be configured to permit unidirectional and/or bidirectional communication between the components and interfaces. For example, the processor 705 can retrieve information from and transmit information to the storage device 710 over the communication bus 715. In an implementation, the communication bus 715 can be comprised of a plurality of busses, each of which couples at least one component or interface of the media client 100 with another component or interface.

The media client 100 also includes a plurality of input and output interfaces for communicating with other devices, including media servers and presentation devices. A wired network interface 720 and a wireless network interface 725 each can be configured to permit the media client 100 to transmit and receive information over a network, such as a local area network (LAN) or the Internet. Additionally, an input interface 730 can be configured to receive input from another device through a direct connection, such as a USB, eSATA or an IEEE 1394 connection.

Further, an output interface 735 can be configured to couple the media client 100 to one or more external devices, including a television, a monitor, an audio receiver, and one or more speakers. For example, the output interface 735 can include one or more of an optical audio interface, an RCA connector interface, a component video interface, and a High-Definition Multimedia Interface (HDMI). The output interface 735 also can be configured to provide one signal, such as an audio stream, to a first device and another signal, such as a video stream, to a second device. Further, a non-volatile memory 740, such as a read-only memory (ROM) also can be included in the media client 100. The non-volatile memory 740 can be used to store configuration data, additional instructions, such as one or more operating instructions, and values, such as one or more flags and counters. In an implementation, a random access memory (RAM) also can be included in the media client 100. The RAM can be used to store media content received in the media client 100, such as during playback or while the user has paused playback. Further, media content can be stored in the RAM whether or not the media content is stored on the storage device 710.

Additionally, the media client 100 can include a remote control interface 745 that can be configured to receive commands from one or more remote control devices (not pictured). The remote control interface 745 can receive the commands through wireless signals, such as infrared and radio frequency signals. The received commands can be utilized, such as by the processor 705, to control media playback or to configure the media client 100. In an implementation, the media client 100 can be configured to receive commands from a user through a touch screen interface. The media client 100 also can be configured to receive commands through one or more other input devices, including a keyboard, a keypad, a touch pad, a voice command system, and a mouse.

A number of implementations have been disclosed herein. Nevertheless, it will be understood that various modifications may be made without departing from the spirit and scope of the claims. Accordingly, other implementations are within the scope of the following claims.

What is claimed is:

1. A method performed by a computer system, the method comprising:
receiving input from a user selecting a media type category;
identifying media content items within the selected media category that the user has previously selected for presentation;
prioritizing the identified media content items based on a predetermined set of rules; and
presenting to the user a menu of at least some of the identified media content items in an order based on a result of the prioritization.

2. The method of claim 1 further comprising displaying indicia in the menu indicating to which of a plurality of different groups the presented media content items belong.

3. The method of claim 2 wherein the groups vary with the selected media type category.

4. The method of claim 2 wherein at least one of the groups corresponds to items of media that are not yet completely played back.

5. The method of claim 2 wherein at least of the groups corresponds to items of media recently acquired.

6. The method of claim 2 wherein at least of the groups corresponds to items of media with upcoming expiration times.

7. The method of claim 2 wherein at least of the groups corresponds to items of media that have been recently accessed.

8. The method of claim 2 wherein at least of the groups corresponds to items of media that are popular according to a predefined metric.

9. The method of claim 2 wherein at least of the groups corresponds to items of media that the user has not yet acquired.

10. The method of claim 1 wherein presenting a menu to the user comprises displaying at least two separate regions including a media type region in which a plurality of different media type categories are displayed and a shelf region in which individual media content items are displayed.

11. The method of claim 10 wherein the media content items displayed in shelf region change in response to change in choice of media type category.

12. The method of claim 10 wherein when an insufficient quantity of media content items exists to fill the shelf, further comprising filling a remainder of the shelf with media content items selected by a third party.

13. The method of claim 1 further comprising designing the set of predetermined rules to result in prioritization of media content items that the user is most likely to want to access.

14. The method of claim 1 further comprising designing the set of predetermined rules to result in media content items that the user is most likely to want to access having a high priority.

15. The method of claim 1 further comprising designing the set of predetermined rules to result in media content items that the user has most recently acquired having a high priority.

16. An article of manufacture comprising a machine-accessible medium including data that when accessed by a machine cause the machine to perform operations comprising:
receiving input from a user selecting a media type category;
identifying media content items within the selected media category that the user has previously selected for presentation;
prioritizing the identified media content items based on a predetermined set of rules; and
presenting to the user a menu of at least some of the identified media content items in an order based on a result of the prioritization.

17. The article of claim 16 further comprising displaying indicia in the menu indicating to which of a plurality of different groups the presented media content items belong.

18. The article of claim 17 wherein the groups vary with the selected media type category.

19. The article of claim 17 wherein at least one of the groups corresponds to items of media that are not yet completely played back.

20. The article of claim 17 wherein at least of the groups corresponds to items of media recently acquired.

21. The article of claim 17 wherein at least of the groups corresponds to items of media with upcoming expiration times.

22. The article of claim 17 wherein at least of the groups corresponds to items of media that have been recently accessed.

23. The article of claim 17 wherein at least of the groups corresponds to items of media that are popular according to a predefined metric.

24. The article of claim 17 wherein at least of the groups corresponds to items of media that the user has not yet acquired.

25. The article of claim 16 wherein presenting a menu to the user comprises displaying at least two separate regions including a media type region in which a plurality of different media type categories are displayed and a shelf region in which individual media content items are displayed.

26. The article of claim 25 wherein the media content items displayed in shelf region change in response to change in choice of media type category.

27. The article of claim 25 wherein when an insufficient quantity of media content items exists to fill the shelf, further comprising filling a remainder of the shelf with media content items selected by a third party.

28. The article of claim 16 further comprising designing the set of predetermined rules to result in prioritization of media content items that the user is most likely to want to access.

29. The article of claim 16 further comprising designing the set of predetermined rules to result in media content items that the user is most likely to want to access having a high priority.

30. The article of claim 16 further comprising designing the set of predetermined rules to result in media content items that the user has most recently acquired having a high priority.

31. A media device comprising:
memory for storing instructions;
a processor for executing instructions stored in the memory to cause the media device to perform operations including:
receive input from a user selecting a media type category;
identify media content items within the selected media category that the user has previously selected for presentation;
prioritize the identified media content items based on a predetermined set of rules; and
present to the user a menu of at least some of the identified media content items in an order based on a result of the prioritization.
